(19) United States
(12) Patent Application Publication
(10) Pub. No.: US 2008/0288318 A1
(43) Pub. Date: Nov. 20, 2008

(54) SMART TRAM SYSTEM AND METHOD FOR USING

(75) Inventor: R. MICHAEL WEBB, LAS VEGAS, NV (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: SMART TRAM CORP., LAS VEGAS, NV (US)

(21) Appl. No.: 12/029,181

(22) Filed: Feb. 11, 2008

Related U.S. Application Data
(60) Provisional application No. 60/912,214, filed on Apr. 17, 2007.

(51) Int. Cl. G06Q 10/00

(52) U.S. Cl. 705/8; 705/1

(57) ABSTRACT

A system and method for providing mass transit is disclosed. The system is able to dispatch a vehicle to a person in response to their contacting a central controller. The system can adjust their route depending on the needs of the person and/or persons who are using the system. The system can place a track in an urban area without adding to the congestion that already exists within the area.

This Application claims the benefit of Provisional Application Ser. No. 60/912,214 filed Apr. 17, 2007, the contents of which are herein incorporated by reference.

### BACKGROUND OF THE INVENTION

1. Field of the Invention

The present invention relates to the field of transportation systems and their methods of use. In particular the present invention relates to a smart tram system and method for using.

2. Description of the Related Technology

Urban areas and their surroundings can suffer massive congestion due to automobile traffic. In addition to causing congestion in cities, as well as wasting land for use as parking lots, automobiles are a major cause of smog and pollution.

Mass transit systems are typically used in order to alleviate the congestion that is caused by automobiles. However, existing mass transit systems do not cater to the needs of individual people and do not offer the flexibility and convenience of automobiles. Generally, mass transit systems try to accommodate a variety of schedules and therefore forego convenience and flexibility. Additionally, mass transit systems can require an enormous amount of new resources and infrastructure in order to put them in place.

Therefore there is need in the field to provide a mass transit system that can provide the flexibility and convenience of automobiles, while also reducing the amount of congestion within an area as well as the pollution.

### SUMMARY OF THE INVENTION

An object of the invention can be a mass transit system that reduces congestion.

Another object of the invention can be a flexible transit system.

Yet another object of the invention can be an environmentally sound transit system.

Still yet another object of the invention can be a personalized transit system.

Another object of the invention can be a transit system that is efficient with both energy and time.

An aspect of the invention can be a system for providing mass transit comprising: a central controller; a database operably connected to the central controller; a traffic controller operably connected to the central controller, a track and a vehicle; and a person, wherein the person transmits travel data to the central controller and the central controller dispatches a vehicle in response to the travel data.

Another aspect of the invention can be a method for providing transportation comprising: transmitting from a person to a central controller travel data, wherein the central controller accesses a database having a profile of the person; providing schedule data from the central controller to the person; transmitting acceptance of the schedule data to the central controller from the person; dispatching a vehicle to a location indicated in the schedule data.

Still yet another aspect of the invention can be a system for providing mass transit comprising: a central controller; a database operably connected to the central controller, wherein the database stores profiles; a traffic controller operably connected to the central controller, a track suspended above ground and a vehicle, wherein the vehicle and the track are powered by DC electricity; and a person, wherein the person transmits travel data to the central controller and the central controller accesses the database for a profile of the person and dispatches a vehicle in response to the travel data and the profile.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a front view of a vehicle used in an embodiment of the present invention.

FIG. 2 is a side view of the vehicle used in an embodiment of the present invention.

FIG. 3 is a side view of the mechanism for attaching the vehicle shown in FIG. 1 to the track.

FIG. 4 shows a front view of the mechanism for attaching the vehicle shown in FIG. 1 to the track.

FIG. 5 is a top down view of a track with a switch section used in the system.

FIG. 6 is a diagram of the components used in an embodiment of the present invention.

FIG. 7 is a flow chart illustrating the method of the present invention.

FIG. 8 is a flow chart illustrating the method for handling a missing rider.

### DETAILED DESCRIPTION OF THE PREFERRED EMBODIMENT(S)

The present invention is a mass transit system and method for using. Unlike existing mass transit systems, the present invention is able to take advantage of existing infrastructure in order to be put into place. However it should be understood that the mass transit system may be built anew without using existing infrastructure. The present invention can be used to provide mass transit while still being able to personalize the experience. The ability to provide a personalized experience while reducing existing traffic and congestion further assists in reducing pollution.

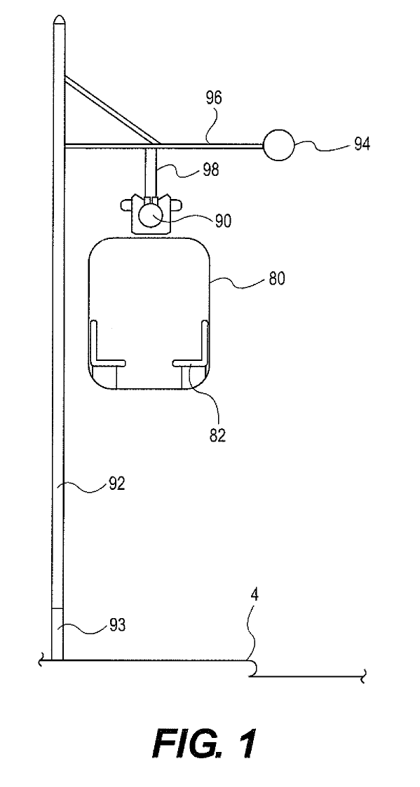

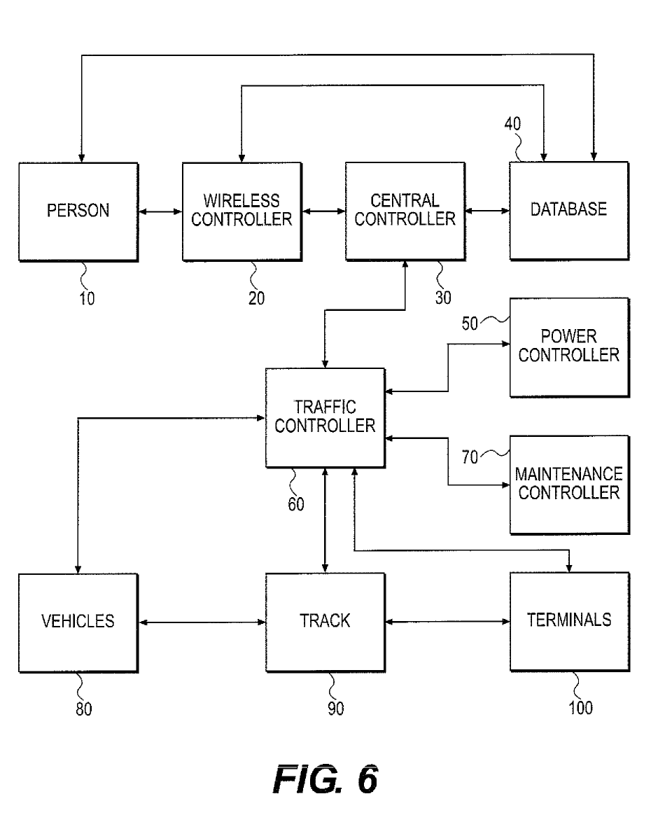

Shown in FIGS. 1-5 is an embodiment of the vehicle 80 and track 90 that can be used in providing the mass transit system 101, shown in FIG. 6. The embodiment shown in FIGS. 1-5 uses a single track 90. Using a single track 90 to support a vehicle 80 to transport people is not new. Previously using a single track system has had limited success due to the cost to install rail, the difficulty in maneuvering vehicles independently and the inefficiencies of a monorail when compared to other forms of mass transportation.

The mass transit system 101 utilizes a variety of innovations that permits this type of mass transportation to be a viable option. Some examples of the advantages that the system 101 can provide are fast, smooth switching from one track to another within a short radius, which increases options for routing within the system 101. The ability for vehicles 80 to make 90-degree turns and move quickly to off-track sidings within a short distance also improves on previous systems. The system 101 can use a central controller 30 and/or traffic controller 60 to route lightweight vehicles 80 the shortest distance between point of departure and destination. The system 101 can also use variable diameter wheels to automatically adjust torque with changes in gravitational force, which thereby minimizes the energy used for propulsion. The system 101 may also use existing cell phone infrastructure and other wireless devices to communicate between the central controller 30, people 10 and vehicles 80.

It is also contemplated that the mass transit system 101 can place tracks 90 in space above public land and existing easements not used by other forms of transportation thereby eliminating possible conflicts and further reducing congestion.

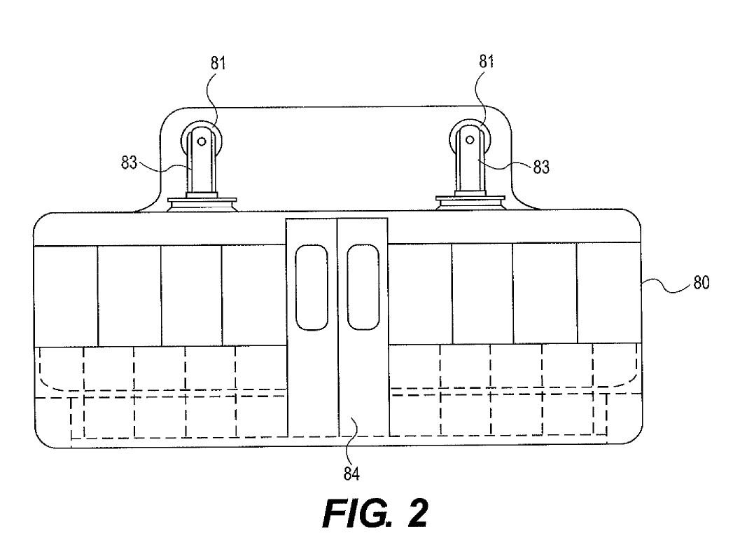

FIG. 1 is a front view of the vehicle 80 that can be used in an embodiment of the present invention. FIG. 2 is a side view of the vehicle 80 that can be used in an embodiment of the present invention.

In FIG. 1, the vehicle 80 is shown in a cross-sectional view thereby illustrating the seats 82 that are provided in the interior of the vehicle in order to provide comfort to a person 10 who will be riding. The vehicle 80 may carry any number of passengers, however it is contemplated that in the embodiment shown the number of passengers that may be carried may number 20 or less. FIG. 2 shows the doors 84 that provide access to the interior of the vehicle 80. In FIGS. 1 and 2, vehicle 80 resembles a suspended tram car, however it should be understood that vehicle 80 is not limited to the shape and configuration shown herein. Also shown in FIG. 2 are drive wheels 81 and drive wheel support structure 83. The drive wheel support structure 83 supports the drive wheels 81 as they propel the vehicle 80 along the track 90 and can release the vehicle 80 from the track 90 by movement of lock pin 86 and rotating away from the track 90 about Pivot Pin 88 for storage and maintenance.

Returning to FIG. 1, a vertical support structure 92 is provided that assists in suspending and supporting the vehicle above the ground 4. The vertical support structure 92 shown in the embodiment is a newly installed pole that is designed to replace existing utility poles, however other devices and structures may be used. For example, the vertical support structure 92 may be a pre-existing building, column, pole, and/or may be a newly constructed structure. Within the base of the vertical support structure 92, may be a battery 93 and/or other DC power source. Battery 93 may be the type of battery used in forklifts. The actual shape and form of the vertical support structure 92 is secondary to its ability to soundly support and maintain the track 90 and the vehicle 80. However, utilization of preexisting infrastructure, such as utility poles, can be preferable in terms of reducing overall costs of providing the system 101.

Still referring to the embodiment shown in FIG. 1, the vehicle 80 is typically supported approximately 4 meters above the ground 4. Extending perpendicularly from the vertical support structure 92 is a track support structure 96 that can extend between 2-3 meters. At a distal end of the track support structure 96 may be a fixture 94 that may be a light, sign or other civic oriented structure. Attached to the top of Vertical Support Structure 92 is fixture 95, which is typically a solar panel, windmill or other type of device that can generate energy and that can be operably connected to the battery 93 located in the base of the vertical support structure 92. The fixture 94 may also be located on top of the vertical support structure 92. Located roughly 1.1 meters from the vertical support structure 92 is the downwardly extending suspension support 98. The suspension support 98 supports the track 90 that is used in facilitating the movement of the vehicle 80 along the track 90.

Still referring to the embodiment shown in FIG. 1 the bottom of the vehicle 80 is roughly 3 meters from the track support structure 96. It should be understood that the distances provided in the example shown in FIG. 1 are merely representative of potential distances that may be used and dimensions may vary depending on the needs and environmental conditions in which the system 101 is going to operate. It should also be understood that while the track 90 is shown being connected to a vertical support structure 92, track support structure 96 and suspension support 98, it may be possible to support the track 90 by using more or less structure depending on conditions. Furthermore, track support structure 96 may extend at angles other than 90° with respect to the vertical support structure 92.

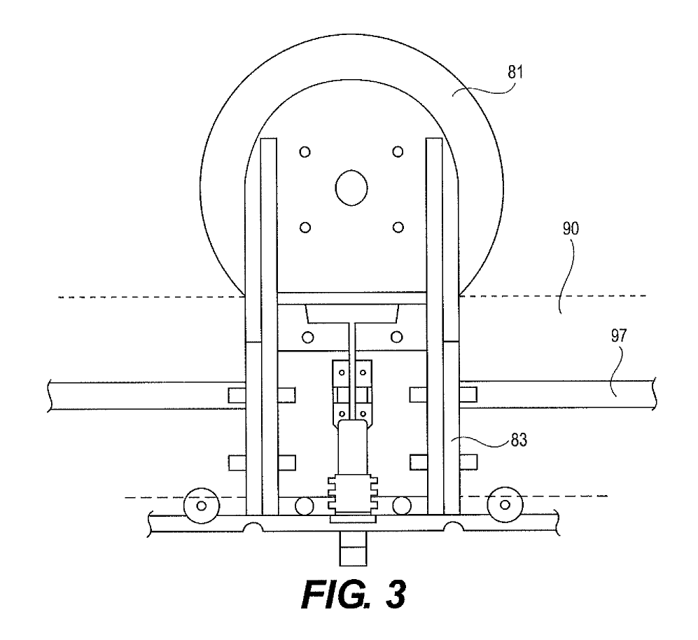

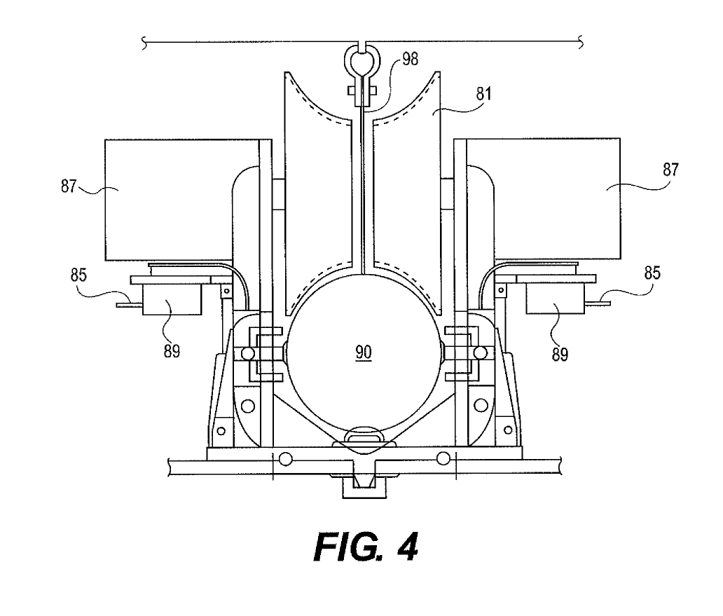

Now turning to FIGS. 3-5, the vehicle 80 is provided with vehicle stabilization features 82, which travel in a groove 84 in the bottom of the track 90 to prevent yaw and oscillation at high speeds. FIG. 3 is a side view of the mechanism for attaching the vehicle 80 shown in FIG. 1 to the track 90. FIG. 4 shows a front view of the mechanism for attaching the vehicle 80 shown in FIG. 1 to the track 90. As shown in the FIGS., the drive wheel support structure 83 supports the drive wheel 81 and further has attached to it DC motors 87. The DC motors 87 have attached to them a control box 89 and antenna 85. The control box 89 can receive instructions from the traffic controller 60 and can transmit data to the various controllers used in the system 101 via the antenna 85. The data transmitted from the control boxes 89 may be energy data, maintenance data and/or other data related to the functioning and operation of the system 101. The track 90 has conductors 97 on opposite sides to provide DC power to the DC motors 87 for propulsion.

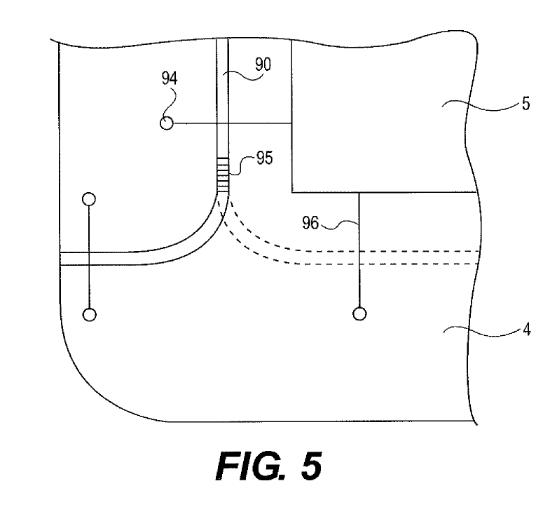

Referring to FIG. 5, the system 101 can utilize counter-balancing springs 95 at intersections to limit the need for heavy switch motors Switching can be accomplished by rotating the track 180°. By using the springs 95 the vehicle 80 can rapidly make 45° turns and 90° turns. The system 101 provides DC power to conductors 97 on either side of the track 90 and can invert at intersections upon switching through the usage of the batteries 93 located at the vertical support structures 92. Braking can be achieved through the reversal of current. The batteries 93 can constantly be recharged by wind, solar and other forms of non-fossil fuels. The usage of these measures to provide energy to the batteries 93 can facilitate the provision of measures for providing clean renewable energy in order to reduce any pollution that may come from the system 101.

As discussed in more detail below, in an embodiment of the present invention, the system 101 uses many small vehicles 80 in lieu of fewer large vehicles. In using smaller vehicles 80, the time waiting for a vehicle 80, time to board a vehicle 80, number of stops in route and energy used per passenger is reduced. The system 101 is ideal for congested metropolitan areas as it is contemplated that existing easements can be used (for example, those easements provided for streets, sidewalks, utilities and railroads), thereby reducing time and cost to acquire land rights. The vehicle 80 moves above the ground 4 using these existing easements. Vehicle stops can be located at the second floor of buildings 5, thereby significantly increasing desirable retail space in the same structure.

Now referring to FIG. 6, wherein a block diagram of the system 101 is shown. The system 101 may comprise a person 10, a wireless service provider 20, a central controller 30, a database 40, a power controller 50, a traffic controller 60, a maintenance controller 70, vehicles 80, a track 90 and terminals 100. The system 101 is designed to route vehicles 80 along the track 90 in order to pick up and drop off persons 10. The system 101 can use GPS signals, as well as other wireless signals, transmitted from vehicles 80 and persons 10 to a master controller 30, which may be linked to the Internet, in order to allow reservations, trip scheduling, rider identification, ensure security and payment.

The person 10 is typically a rider who intends to use the system 101 and is usually preregistered as a user of the system 101. The person 10 is able to transmit travel data via a wireless service provider 20 to a central controller 30 and database 40. Information regarding the person 10 may be stored in the database 40. Information stored about the person 10 may simply be their billing information and typical travel itinerary, however it is contemplated that information regarding a personal tastes, preferred routes, etc. may also be stored in order to schedule trips with persons 10 with similar tastes. It is contemplated that most persons 10 who are using the system 101 have already enrolled in travel program.

A person 10 may enroll in the system 101 by providing relevant information related to billing, etc. Alternatively, the person 10 may simply be a person who wishes to ride the system 101 and may not be enrolled in the database 40. In the event that a person 10 is not enrolled in database 40, it may be possible when requesting transportation through the usage of a wireless device to indicate that the cost should be billed to their wireless service provider 20, which could then bill the person 10. It is anticipated that a GPS signal indicating the location of the person 10 may also be transmitted via the wireless service provider 20 to the central controller 30.

Still referring to FIG. 6, wireless service provider 20 provides wireless service to the person 10 and enables communication between the person 10 and the system 101. The wireless service provider 20 is typically a cell phone service, etc. When requesting usage of the system 101 the person 10 will typically use the wireless service provider 20 in order to transmit travel data to the database 40 and/or the central controller 30. Wireless service provider 20 may also provide tracking and location information to the central controller 30 regarding the whereabouts of the person 10. In some embodiments, the wireless service provider 20 may directly bill the person 10 for the transportation services.

Central controller 30 operates as the hub of the system 101. The central controller 30, may be a computer having a processor, an array of computers, a distributed computing system, a localized area network, or a wide area network, etc. The central controller 30 stores those instructions related to the direction and running of the system 101. The central controller 30 authorizes the dispatch and recall of vehicles 80 through communication with other components of the system 101. The central controller 30 can validate whether or not a person 10 may use the system 101 and may also track both persons 10 within the system 101 and the vehicles 80 within the system 101 using GPS signals or other data useful for tracking. The central controller 30 can also report trip completion and update billing information. The central controller 30 is operably connected, to the wireless service provider 20, the rider database 40 and the traffic controller 60. When reference is made to a component being “operably connected” it should be understood to mean that the component may be connected either directly or indirectly, wirelessly or via cables, so long as communication between the two components is possible.

The database 40 stores profiles and information about the person 10. The person 10 may keep billing information and riding information stored on the database 40. The database 40 may store past riding history for a person 10 as well. Riding history may include data related to normal riding patterns, such as pickup and drop-off times, locations, routes, etc. The database 40 may be in operable connection with the central controller 30, wireless controller 20 and the person 10. The database 40 may be housed in the same unit or computer as the central controller 30. The database 40 receives travel data from the person 10 and provides the travel data to the central controller 30, which then instructs the traffic controller 60 to dispatch and/or reroute vehicles 80 in response to the travel data. The database 40 can also send billing information to the wireless service provider 20. The database 40 can also receive payment notices from the wireless service provider 20 and can update profiles of the people 10. The database 40 can also transmit profile updates to persons 10 via text message.

Power controller 50 is operably connected to the traffic controller 60. The power controller 50 monitors the power level at all source points, such as batteries 93, specific track locations, etc. This can be accomplished via the usage of monitoring devices and sensors on the tracks 90 and via the usage of the control box 89 and antenna 85 located on the vehicle 80, as well as monitoring devices that can be located on the batteries. The power controller 50 may also provide data to switches to initiate backup power upon high demand and/or low generation of power. The power controller 50 may also order maintenance of and replacement of power batteries 93.

Traffic controller 60 issues instructions to the vehicles 80 regarding where to go on the track 90. The traffic controller 60 receives instructions from the central controller 30 regarding where to send vehicles 80 in order to pick up and/or drop-off persons 10. The traffic controller 60 can issue instructions in order to find the shortest path and maximize the efficiency of traffic on the system 101. Traffic controller 60 also sends instructions for switching the direction of the track 90 and direction of vehicles 80 on the track 90. The traffic controller 60 is operably connected to the central controller 30, the power controller 50, the maintenance controller 70, the track 90, the vehicles 80 and the terminals 100. The traffic controller 60 can also signal a person upon arrival at a terminal 100, can send a signal to open a terminal gate, send signal to open the vehicle doors 84, check for added weight and issue instructions to proceed to the next destination. Traffic controller 60 may also control the speed of the vehicle 80; routing of the vehicle 80 and can activate switches on the track 90.

Maintenance controller 70 can receive warning signals from the track 90, vehicles 80 and the traffic controller 60 regarding the status of the various components of the system 101. When a need for maintenance is required a warning is sent to the maintenance controller 70 and it can dispatch service vehicles and/or personnel to the location of the problem. The maintenance controller 70 can communicate with the central controller 30 and the traffic controller 60. The maintenance controller 70 can also issue instructions to remove vehicles 80 from the track 90. The maintenance controller 70 can also maintain storage and service facilities by keeping them supplied and ordering more supplies when a shortfall occurs. Service and maintenance scheduling may also be maintained by the maintenance controller 70.

It should be understood that while the central controller 30, the database 40, the power controller 50, the traffic controller 60 and the maintenance controller 70 are all discussed herein as separate, it is possible to have these various components housed within the same computer system or alternatively distributed amongst a variety of systems.

Terminals 100 may be any structure that provides a location where the vehicles 80 may stop to load and unload persons 10. It is contemplated that the terminals 100 may be located on the second floors of some structures at ground level or may be free standing structures. The terminals 100 may also assist in monitoring aspects of the system 101 and may transmit data related to the health of the system 101 and be operably connected to the traffic controller 60. It is further contemplated that devices may be present at terminals 100 that would permit a person not having immediate access to a wireless service provider 20 to contact the database 40 and/or central controller 30 in order to request transportation.

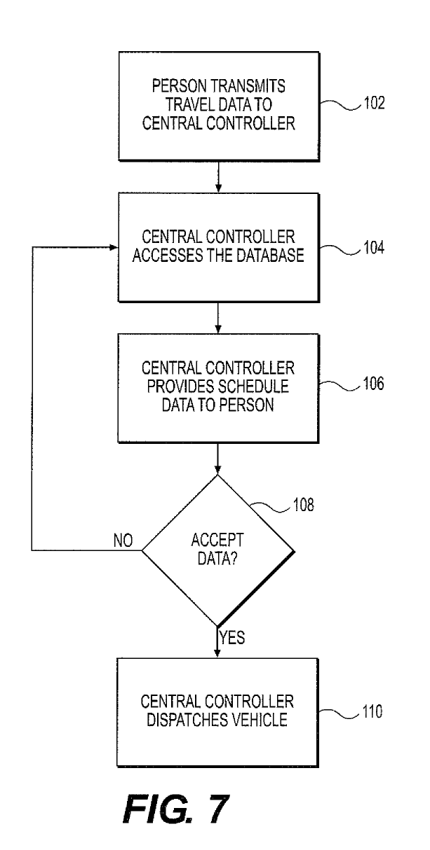

Now turning to FIG. 7 wherein a flow chart illustrating a method for using the system 101 is shown. In step 102, a person 10 contacts the central controller 30 and provides travel data. Travel data is the preferred time, location (such as terminal 100), and schedule of stops that a person 10 requests of the system 101. This is typically accomplished via the usage of the wireless service provider 20. The person 10 may contact the central controller 30 either directly and/or via the database 40 through the usage of the wireless service provider 20. The person 10 may already have stored within the system 101 preprogrammed travel data that may be easily accessed and referenced, or used to dispatch vehicles 80 on a pre-determined schedule.

In step 104, the central controller 30 accesses the database 40 in order to retrieve a profile of the person 10 and data related to the vehicles 80 and the track 90 as well as process the travel data. The central controller 30 can verify the status of the person 10, whether inactive or active. The central controller 30 can communicate with the traffic controller 60 in order to target the person 10 and provide the profile of the person 10 in order to obtain relevant scheduling data.

In step 106 the central controller 30 provides scheduling data to the person 10. Scheduling data is data related to the time and location and possible schedule of stops that the system 101 would be making in view of the existing conditions. The schedule data may include but is not limited to the pick-up time, location and estimated time in route.

In step 108 the person 10 indicates whether or not the scheduling data is acceptable. If the scheduling data is unacceptable the method returns to step 104 where the central controller 30 reprocesses the travel data and creates an alternative schedule data. Upon acceptance by the person 10, in step 110 the central controller 30 dispatches the vehicle 80. At the terminal 100 the vehicle doors 84 are opened, the added weight of the person 10 may be checked and the vehicle 80 can proceed to its destination.

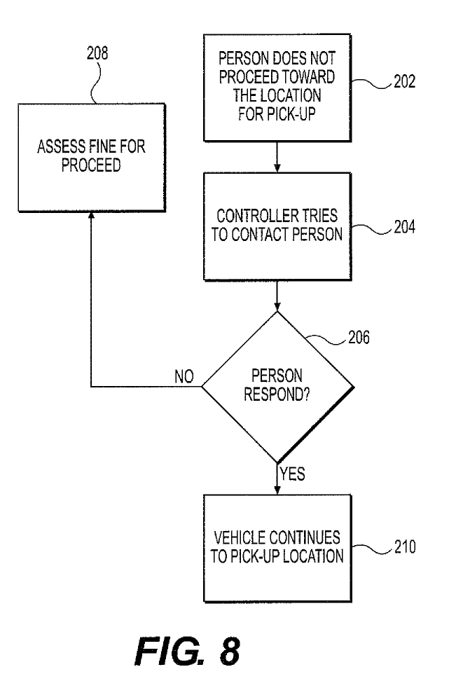

Now turning to FIG. 8, wherein a flow chart illustrating the method for handling a person who misuses the system 101 is shown.

In step 202, the system 101 determines if the person 10 is moving towards the location for pick up. This can be accomplished via the usage of GPS signals.

In step 204, if the central controller 30 determines that the person 10 is not proceeding towards the location for pick up an attempt to contact the person 10 is made.

In step 206 it is determined if the person 10 is responding to the central controller 30. A predetermined time limit for response can be set. In step 208 if a person 10 does not respond to the attempt to contact him or her from the central controller 30, the central controller 30 cancels the ride and assesses a fine that can be billed to the person 10. In step 210 if the person 10 responds to the contact attempt the vehicle 80 continues to the location for pick up.

Other advantages and uses of the system will now be discussed below. Prior to and upon boarding of a vehicle 80, persons 10 with similar destinations as the person 10 who originally contacted the system 101 can be correlated with vehicle routing electronically to minimize time to ultimate destination. In another embodiment of the system 101, persons 10 can own personal vehicles, which could run errands, pick them up at work and reduce the time and productivity lost in transit. It may be possible to reserve passage on vehicles with persons 10 possessing similar personality profiles so as to provide an enjoyable journey to their destination. Vehicles 80 may have additional features and services such as specialized services, storage facilities, and unique vending located about the system 101.

Other advantages can be the ability to use unattended vehicles 80 thereby reducing operational costs. Another advantage is that the vehicles 80 occupy space not used by other forms of transportation, and can have the following features: energy efficient, environmental friendly, system 101 powered by batteries 93 constantly recharged by wind, water, sun and other forms of energy. Vehicles 80 need only stop when summoned, thereby reducing transit time. Persons 10 who use the system 101 may be required to be pre-authorized thereby ensuring safety of other passengers. Vehicles 80 may detach and reattach themselves from or to the track 90. The system 101 may have multiple power-generation devices feeding the same reserves. Vehicles 80 may remain idle if not called instead of running a predetermined route thereby reducing energy costs as well as maintenance costs. The track 90 may be arranged so that vehicles 80 may pass those vehicles stopped at boarding points. The track can permit left and right 90° turns. The system 101 may have preset speeds throughout the route to minimize time and maximize comfort. The system 101 may use variable diameter wheels to automatically adjust torque with gravitational force in order to conserve energy. The system may permit two or more vehicles 80 to follow each other, stop independently and/or pass one another. Spacing between vehicles may be determined by GPS, sensors and the central controller 30 and/or the traffic controller 60.

In general the system and method of the present invention provides an energy efficient way of transporting small groups of people to various locations in a timely and energy efficient manner.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A system for providing mass transit comprising:
a central controller;
a database operably connected to the central controller;
a traffic controller operably connected to the central controller, a track and a vehicle; and
a person, wherein the person transmits travel data to the central controller and the central controller dispatches a vehicle in response to the travel data.

2. The system of claim 1, wherein the central controller dispatches the vehicle through the transmission of travel data to the traffic controller.

3. The system of claim 1, further comprising a power controller operably connected to the traffic controller, wherein the power controller is adapted to monitor batteries and energy in the system.

4. The system of claim 1, further comprising a wireless service provider operably connected to the central controller, wherein travel data is transmitted from the wireless service provider to the central controller.

5. The system of claim 1, further comprising a maintenance controller, wherein the maintenance controller is adapted to schedule maintenance for the track and the vehicle.

6. The system of claim 1, wherein the database stores profiles of the person, wherein the profile includes billing data.

7. The system of claim 1, wherein the track is a monorail.

8. The system of claim 1, wherein the track is suspended about four meters above the ground.

9. The system of claim 1, wherein the track uses DC current.

10. The system of claim 1, further comprising a vertical support member for supporting the track, wherein a battery is stored in the vertical support member.

11. The system of claim 10, further comprising a track support structure extending perpendicularly from the vertical support member.

12. The system of claim 11, further comprising a fixture connected to the track support structure.

13. The system of claim 12, where the fixture is a solar panel operably connected to the battery.

14. A method for providing transportation comprising:
transmitting from a person to a central controller travel data, wherein the central controller accesses a database having a profile of the person;
providing schedule data from the central controller to the person;
transmitting acceptance of the schedule data to the central controller from the person;
dispatching a vehicle to a location indicated in the schedule data.

15. The method of claim 14, wherein the travel data is transmitted via a wireless service provider.

16. The method of claim 14, further comprising updating the database to reflect billing of the person.

17. The method of claim 14, further comprising monitoring the location of the person.

18. The method of claim 14, further comprising fining the person for not moving to the location indicated in the schedule.

19. The method of claim 14, further comprising adjusting routing of a plurality of vehicles based upon the acceptance of the schedule data.

20. A system for providing mass transit comprising:
a central controller;
a database operably connected to the central controller, wherein the database stores profiles;
a traffic controller operably connected to the central controller, a track suspended above ground and a vehicle, wherein the vehicle and the track are powered by DC; and
a person, wherein the person transmits travel data to the central controller and the central controller accesses the database for a profile of the person and dispatches a vehicle in response to the travel data and the profile.
